(19) United States
(12) Patent Application Publication
(10) Pub. No.: US 2025/0056146 A1
(43) Pub. Date: Feb. 13, 2025

(54) WIRELESS EARBUD COMPRISING AN IMPROVED EARBUD CUSHION SYSTEM PROVIDING A CONTROLLABLE FASTENING MECHANISM INSIDE AN EAR CANAL

(71) Applicant: TK&H HOLDING AS, Tjøme (NO)

(72) Inventors: Tom AUSTAD, Tjøme (NO); Hans ZWART, AG Apeldoorn (NL)

(21) Appl. No.: 18/685,332

(22) PCT Filed: Aug. 29, 2022
(86) PCT No.: PCT/EP2022/073956

§ 371 Date: Feb. 21, 2024

(30) Foreign Application Priority Data
Aug. 30, 2021 (NO) 20211041

(51) Int. Cl. H04R 1/10; H04R 25/00

(52) U.S. Cl. CPC H04R 1/1016; H04R 25/402; H04R 25/656; H04R 2420/07; H04R 2460/11

(57) ABSTRACT

The present invention relates to an earbud cushion system attachable to an earbud body insertable into a human ear, wherein the earbud cushion system can expand or retract in diameter via control of adapted actuator bodies dependent on commands issued wirelessly to configured electronics inside the earbud body thereby facilitating a controlled fastening and release of the earbud cushion positioned inside an ear canal. An indent in a side surface of the earbud body functions as an air vent.

### FIELD OF THE INVENTION

The present invention relates to an improved wireless earbud device comprising an earbud cushion that is configured to expand respectively be reduced in length in at least two independent diagonal directions across the earbud cushion's cross section.

### BACKGROUND OF THE INVENTION

Wireless earbuds used in communication with smart phones is very common. Use of earbuds communicating wirelessly with hearing aid systems is also part of prior art. Hearing loss or reduced hearing ability can be a complicated condition for example being related only to certain frequency ranges of sound. Therefore, hearing aid systems usually require more sophisticated electronic circuitry configured to compensate a reduced hearing capability within a specific frequency range or ranges, for example. Most hearing aid systems comprises a system body having electronic circuitry adapted to a specific patient's hearing condition attachable around an upper part of the outer ear, wherein the hearing aid system supports a loudspeaker facing the ear canal opening leading sound waves towards the ear drum of the ear.

Typical earbuds used in connection with smart phones comprises a body configured to fastens itself to an ear via insertion of a soft earbud cushion surrounding a loudspeaker opening. Only a small part of the earbud cushion is inserted into the ear canal. The rest of the body protrudes outside the ear opening. A common experience with such earbuds is that they may easily fall out of an ear opening. There are also examples of earbuds that do not use earbud cushions and the fastening is achieved by the earbud body shape being adaptable to the outer anatomy of the ear, but experience is that they still quite often may fall out of the ear.

Earbuds used in connection with hearing aid systems usually fits better to an ear opening because the earbud shape is usually tailor made to the outer ear anatomy of a patient. However, the improved stationary behavior of loudspeakers of hearing aid systems is mostly due to how the system body supports the attached loudspeaker mechanically.

A beneficial solution could be to insert an earbud inside the ear canal and allow for example a wireless antenna to protrude out of the ear opening enabling wireless communication with configured wireless communication electronics inside the inserted earbud device.

However, the insertion of an earbud may result in an acoustic sealing if the earbud fits well to the ear canal walls. When a membrane of a loudspeaker of an earbud device moves back and forth, when reproducing sound, air in front of the earbud is moved back and forth thereby moving the ear drum which the human brain can interpret as the communicated sound (speech, music etc.). The acoustical problem may arise when the earbud is tightly fit and fastened inside the ear canal such that the space between the loudspeaker and the ear drum is a closed space. Thereby the closed space influences the quality of the sound providing a “box” like sound. On the other hand, if the ear canal is not closed noise or sound from ambient sound sources can pass the outside surface of an inserted earbud. If the surrounding sound is an abrupt high volume noise pulse or a high-pitched sound the ear may be damaged. This is a known problem. Therefore, having a controlled open/closed state of an earbud inserted into an ear canal may be beneficial. It is also known that varying a dimension of an airing canal that is adapted to bring outside air past an earbud device can provide a frequency filtering and even amplification of sound signal amplitudes of certain frequency ranges of sound.

WO 2019199705 disclose an embodiment of a technology including Tri-Ear Buds (Three triple flanged tips) for a wireless in-ear utility device with in-ear frequency filtering which can also offer a horn that increases the wireless in-ear utility device's ability to deliver sound. Respective Tri-Ear Bud Tips includes micro channels configured to provide low frequency filtering in the range of 50 Hz to 300 Hz and assist in high quality sound performance output. The respective channels length and width can aid in filtering out different frequencies. The horn effect can provide higher sound levels while consuming lower battery power. Embodiments of the technology can include accommodation for a balance between the wearable in-ear devices and hearing aids, such as to accommodate the wearable device requiring more sealing in the ear canal for better sound quality, to accommodate the hearing aid seals requiring more leakage for allowing for the user's voice to have an increased naturalness in sound, where the balance between the both can be frequency leakage in the 50 Hz to 300 Hz, which can allow for the seal to produce high quality performance.

Therefore, there is a need of an improved earbud device facilitating improved fastening and release of the earbud device and at the same time is configurable providing a controllable degree of fitting of an earbud cushion of the earbud device towards an ear canal walls, thereby controlling an amount of external air entering past the earbud device towards an eardrum of an ear the earbud is inserted.

### OBJECT OF THE INVENTION

It is a further object of the present invention to provide an alternative to the prior art.

In particular, it may be seen as an object of the present invention to provide an earbud device having an earbud cushion wherein at least two independent actuators can extend or reduce at least two different diagonal lengths of the earbud cushion's cross section.

### SUMMARY OF THE INVENTION

Thus, the above-described object and several other objects are intended to be obtained in a first aspect of the invention by providing a earbud cushion system attachable to a earbud body comprising at least two actuator bodies spanning at least two different directions of a cross section of a ring-shaped part of an earbud cushion.

The invention is particularly, but not exclusively, advantageous for obtaining a wireless earbud device comprising: an earbud cushion system attachable to a wireless earbud body comprising:
a support structure extending through an earbud cushion body from an end surface of the earbud body (10), wherein the support structure supports at least:
a first actuator body, a second actuator body, a third actuator body, a fourth actuator body all attached in one end to an outer surface of the support structure and in respective opposite ends of the respective actuator bodies to a respective actuator ending element in contact with an inner surface of a ring-shaped part of the earbud cushion body, wherein
the first actuator body and the second actuator body span a first diagonal direction across a cross section of the ring-shaped part of the earbud cushion, and
the third actuator body and the fourth actuator body span a second diagonal direction across the cross section of the ring-shaped part of the earbud cushion.

Respective aspects of the present invention may each be combined with any of the other aspects. These and other aspects of the invention will be apparent from and elucidated with reference to the embodiments described herein.

### DESCRIPTION OF THE FIGURES

The earbud cushion system according to the present invention will now be described in more detail with reference to the accompanying figures. The attached figures illustrate an example of embodiment of the present invention and is not to be construed as being limiting to other possible embodiments falling within the scope of the attached claim set.

FIG. 1 illustrates respective aspects of an example of embodiment of the present invention.

FIG. 2 illustrates further aspects of the embodiment illustrated in FIG. 1.

FIG. 3 illustrates another example of embodiment of an earbud cushion according to the present invention.

FIG. 4 illustrates an example of operating the example of embodiment illustrated in FIG. 3.

FIG. 5 illustrates an example of operating the example of embodiment illustrated in FIG. 3.

### DETAILED DESCRIPTION OF AN EMBODIMENT

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. Further, the mentioning of references such as “a” or “an” etc. should not be construed as excluding a plurality. The use of reference signs in the claims with respect to elements indicated in the figures shall also not be construed as limiting the scope of the invention.

Furthermore, individual features mentioned in different claims, may possibly be advantageously combined, and the mentioning of these features in different claims does not exclude that a combination of features is not possible and advantageous.

An earbud device insertable into an ear canal may be moveable forward or backwards inside an ear canal since the diameter of the earbud device must be smaller than the diameter of the ear canal itself. A human ear canal is not a uniform canal. The ear canal is usually curved and has a variable diameter along the ear canal length towards an ear drum. Ear canal dimensions may also be age related. Infants has smaller ear canal dimensions than adult people for example.

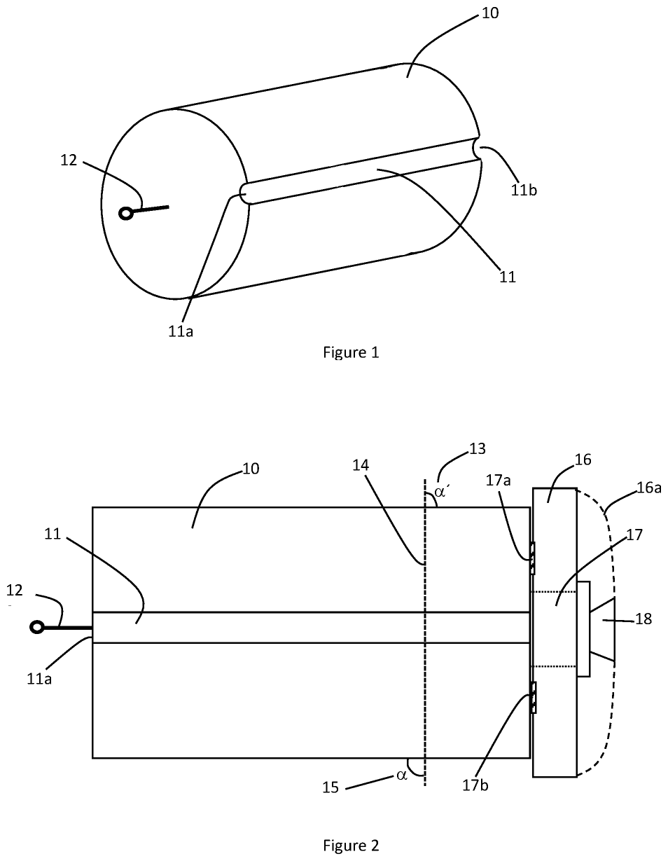

FIG. 1 illustrates an example of a cylinder-shaped earbud body 10 according to the present invention comprising an antenna 12 extending outwardly from a first end surface of the earbud body 10. The antenna 12 is configured to extend outside an ear canal opening when the earbud body 10 is inserted into a human ear.

The outer diameter of the earbud body 10 is adapted to fit a plurality of human ear dimensions. In the example of embodiment illustrated in FIG. 1 there is also arranged an indent on the outer body surface of the earbud body 10 defining an airing canal 11 having an open surface in the longitudinal direction of the airing canal 11. At the respective end surfaces of the earbud body 10 the indent or airing canal 11 leaves a respective open surface 11a, 11b orthogonal to the longitudinal length of the airing canal 11. The indent or airing canal 11 is configured to provide an airing canal that may provide air into a front part of the earbud body 10 facing an eardrum when the earbud body 10 is inserted into a human ear canal even when an earbud body 10 is fitted well to the ear canal walls.

The earbud body 10 comprises configured electronics that may receive instructions, data parameters etc. wirelessly from an external source, for example a hearing aid system or a smart phone etc. These communicated data may provide a setting of different functions etc. of the configurable electronics inside the earbud body 10. Sound received wirelessly by the antenna 12 may be processed by configured electronics according to specific hearing problems of a user of an earbud 10 according to the present invention or is just reproducing sound signals sent from a smart phone, for example.

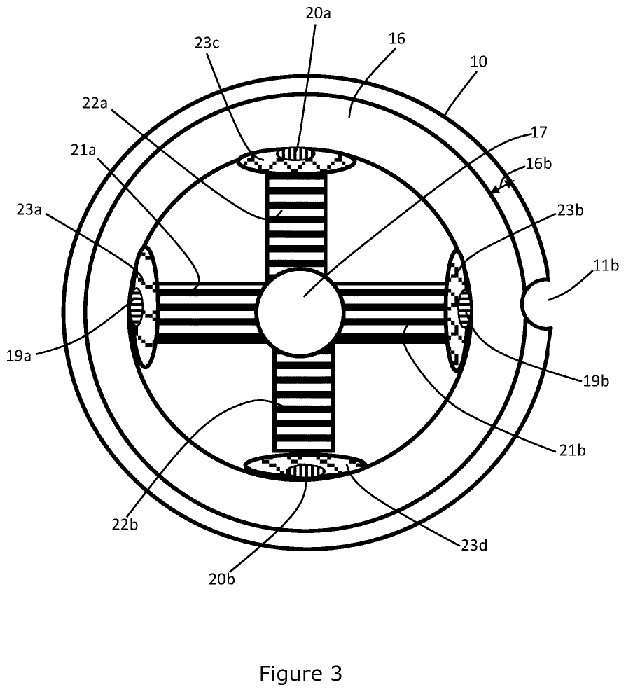

FIG. 2 illustrates further details of the example of an earbud body 10 of the present invention. The line 14 illustrates a possible location on the outer surface of the earbud body 10 wherein an end-part of the earbud body can have an inclination angle relative to the rest of the earbud body. Such an angle can be necessary when adapting the hearing aid body 10 to a typical bend that may be inside an ear canal. For example, if the bending requires an angle of ten degrees relative to the length axis of the earbud body 10, the angle α′ with reference numeral 13 may be one hundred degrees while the angle α referenced by the reference numeral 15 may be eighty degrees relative to the longitudinal axis of the earbud body 10.

A second end surface of the earbud body 10 located opposite the first end surface supporting the antenna 12 is configured with a loudspeaker 18 supported by a support structure 17 like for example a cylinder-shaped support. The cylinder-shaped support 17 can be connected to the second end surface of the earbud body 10 and can support electronic wires, printed circuits boards etc. which can be connected to configured electronics inside the earbud body 10 communicating electronic control signals and sound signals for example to the loudspeaker 18.

An earbud cushion 16 is adapted to be supported by for example the cylinder-shaped support 17. The earbud cushion 16 can have a body part being shaped as a ring-shaped part. The FIG. 2 illustrates that the earbud cushion 16 may have an outer surface 16a that stretches down to the opening of the loudspeaker 18 and surrounds the opening of the loudspeaker 18.

The material of the ring-shaped part of an earbud cushion 16 and the surface extension 16a is a flexible and stretchable material, for example synthetic rubber.

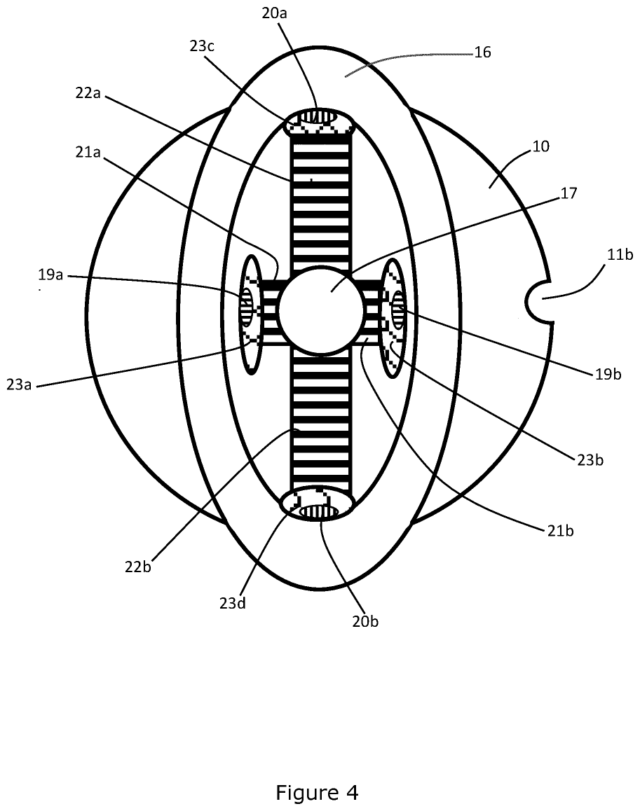

FIG. 3 illustrates further details of an earbud cushion 16 according to the present invention. The view direction is towards the second end surface of the earbud body 10 facing towards the loudspeaker 18.

The cylinder-shaped support 17 may provide support for respective actuators 21a, 21b, 22a, 22b which have actuator bodies being extendable in length as well as being reducible in length dependent on respective control signals delivered via signal lines through the cylinder-shaped support 17 from configured electronics inside the earbud body 10. A first actuator 21a and a second actuator 21b is arranged on opposite sides of the cylinder-shaped support 17 but runs straight in series along a first diagonal direction inside the inner space of the earbud cushion 16 inside the ring-shaped part of the earbud cushion. Respective ends of the respective first and second actuators 21a, 21b is configured with elongated actuator ending elements 23a, 23b in respective ends of the actuators facing towards an inner side surface of the ring-shaped part of the earbud cushion 16. The shape of the elongated actuator ending element is adapted to the curvature of the ring-shaped part of the earbud cushion 16.

A third actuator 22a and a fourth actuator 22b is arranged attached in one end on respective opposite located surfaces of the cylinder-shaped support 17 and runs in series along a second straight diagonal direction. The respective ends of the third and fourth actuators 22a, 22b is configured with respective elongated actuator ending elements 23c, 23d adapted in shape to the curvature of the ring-shaped part of the earbud cushion 16.

The number of actuators is not a fixed number. However, the preferable number of actuators should allow extension and reduction of length of respective actuator bodies in at least to different diagonal directions relative to a cross section of the ring-shaped part of the earbud cushion 16. For example, the two diagonal directions may be orthogonal to each other as illustrated in FIGS. 3, 4 and 5.

The respective elongated actuator ending elements 23a, 23b, 23c, 23d arranged in the respective ends of the actuator bodies may be configured to fasten the ring-shaped part of the earbud cushion 16 to the earbud body 10.

It is further within the scope of the present invention that for example two actuator bodies arranged functioning in series along a defined direction not necessarily needs to run in a straight line. An angle between the two actuator bodies is possible. An advantage of this possibility is that a specific earbud body can be tailormade to a specific anatomy of an ear canal, for example due to outgrowths in the ear canal wall.

When for example a first actuator 21a is attached to an outer surface of the cylinder-shaped support 17 the position on the outer surface will be in a defined distance from the end surface of the earbud body 10 supporting the cylinder-shaped support 17. When the second actuator 21b is attached to the outer surface of the cylinder-shaped support 17 the second actuator can be attached in a same distance from the first actuator 21a. However, it is possible that the second actuator 21b is attached with a slightly different distance from the earbud body 10 than the distance of the first actuator 21a. The end of the second actuator 21b in contact with the inside of the ring-shaped part of the earbud cushion 16 will then provide a slightly off-axis pressure point relative to the pressure point of the first actuator relative to the direction of the cylinder-shaped support 17. This feature may move the pressure point of the second actuator 21b on the ear canal wall away from sensitive parts of the ear canal.

In an example of embodiment of the present invention respective actuators may be connected to an outer surface of a cylinder-shaped support 17 via configured brackets allowing movement of an attached actuator body in two directions orthogonal to each other. Respective brackets may also provide a possibility to adjust an angle of an axis of an attached actuator body relative to a surface normal to the cylinder-shaped support surface at the location of a bracket. A bracket may comprise two surface plates arranged on top of each other such that one plate is movable relative to the other plate. It is also possible to adjust an angle of the upper plate facing the attached actuator by tilting the upper plate relative to the lower plate arranged below the upper plate and wherein the lower plate of the two plates is attachable to the outer surface of the cylinder-shaped support 17.

Therefore, it is possible to control positions of respective pressure points from an actuator in two dimensions on an ear canal surface. The size of the ring-shaped part of the earbud cushion 16 can be adapted to cover respective off-axis pressure points when relative positions between actuators changes.

It is also within the scope of the present invention that other support means than the cylinder-shaped support 17 can be used. For example, FIG. 2 illustrates a respective connection element 17a and 17b the ring-shaped part of the earbud cushion 16 may be attached to. An edge of the ring-shaped part of earbud cushion 16 facing towards the earbud body 10 may extend downwards a defined length which enables a simple attachment of the earbud cushion to the respective connection elements 17a, 17b.

Protruding parts of the respective connection elements 17a and 17b (not illustrated) may support respective actuators.

Inside each actuator ending elements 23a, 23b, 23c, 23d there is arranged a pressure sensor. The first actuator end 23a of the first actuator 21a is configured with a first pressure sensor 19a. The second actuator end 23b of the second actuator 21b is arranged with a second pressure sensor 19b. The third actuator end 23c of the third actuator 22a is configured with a third pressure sensor 201. The fourth actuator end 23d of the fourth actuator 22b is configured with a fourth pressure sensor 20b.

The first and second actuator 21a, 21b running along a same diagonal direction have the first and second pressure sensors 19a, 19b located on opposite ends facing towards the inner surface of the ring-shaped part of the earbud cushion 16.

The respective first, second, third and fourth actuators are controlled by electronic signals provided by configured electronics inside the earbud body 10. These signals can be activated via for example commands issued as wireless commands from an external hearing aid system or a smart phone for example. A specific signal can activate an extension of the length of an actuator, for example. The duration of the signal may control the extent of extension that takes place. Another specific signal may reduce the length of an extended actuator. The amount of reduction may be controlled by the duration of the signal.

However, each pressure sensor may provide feedback signals to the configured electronics issuing the signals extending or reducing a length of an actuator. When an actuator ending element 23a, 23b, 23c, 23d meets an inside wall of an ear canal the respective actuator ending element is pushing towards the wall when the corresponding extension signal activates the corresponding actuator. The feedback signal from the pressure sensor can be compared with a settable threshold level which may result in a termination of the extension of the length of the respective actuators if for example the pressure signal level is above the defined threshold level. In this manner it is possible to avoid extensive pressure towards the ear canal wall which may be painful. Further, since the anatomy can be different from one person to another, the feedback pressure sensor signal allows the extension to be adapted to the concrete size of an ear canal of respective users of the earbud device using the earbud cushion of the present invention.

The example of embodiment according to the present invention disclosed above makes it possible to adapt the fitting of the earbud cushion 16 more accurate to changing anatomy of respective ear channels an earbud according to the present invention is inserted, i.e., the earbud cushion can adapt to non-symmetrical ear canal profiles.

The extension of the first and second actuator 21a, 21b along the same diagonal direction may be done with equal lengths of extensions on both sides of the cylinder-shaped support 17. However, the feedback signals from respective pressure sensors are configured to control each respective actuator extension signals independently. This implies if for example the extension signal extending the first actuator 21a is terminated because the pressure signal from the pressure sensor 19a exceeds a predefined signal level, the extension of the first actuator 21a stops. However, the extension of the second actuator 21b may continue until the pressure signal from the pressure sensor 19b exceeds a defined pressure level. This enables an individual adaption of the fastening of the earbud cushion to the ear canal walls independently in tow opposite directions.

The same applies for the third and fourth actuator 22a, 22b. Therefore, the example of embodiment illustrated in FIG. 3 allows a fastening of the earbud cushion in four points around the circumference of an ear canal.

FIG. 3 illustrates a situation wherein the ring-shaped part of the earbud cushion 16 does not extend longer than a distance 16b from the periphery of the end surface of the earbud body 10 the cylinder-shaped support 17 is protruding from. This configuration leaves the orthogonal surface 11b of the airing canal 11 open.

FIG. 4 illustrates a configuration where the third and fourth actuator 22a, 22b are extended while the first and second actuator 21a, 21b is positioned in a retracted state. This results in an oval or elliptic shape of the ring-shaped part of the earbud cushion 16. This configuration provides a possible opening on both sides, i.e., adjacent to the first actuator end 23a and the second actuator end 23b, of the earbud body 10 stretching into free air at the ear canal opening. The acoustical condition is therefore “open” in this configuration while the earbud body 10 is fastened to the ear canal walls via the third and fourth actuator 22a, 22b.

Dependent on the anatomy of a specific ear canal, the openings adjacent to the respective first actuator end 23a and the second actuator end 23b the opening may be too narrow to really establish an acoustical “open” configuration. However, the second actuator end 23b is located away from the orthogonal surface 11b of the airing canal 11. Therefore, the airing canal 11 is dimensioned to provide the “open” acoustical property when the surface is not covered by the earbud cushion 16 regardless of the anatomy of the ear canal the earbud is inserted.

However, it is within the scope of the present invention to have an example of embodiment relying only on the opening created between the earbud cushion and an adjacent part of the ear canal wall when adapting the earbud cushion 16 to a specific acoustical condition when a respective one of the actuator bodies are not extended to its full length. By increasing the extended length further or reducing the length in a gradual manner, different opening sizes are created allowing changing the acoustical property from open to closed state and vice versa providing a plurality of intermediate acoustical configurations. This configuration may allow a filtering of ambient sound and noise entering the ear canal. It is within the scope of the present invention that different positions of a respective one of the actuator bodies are pre-programmed and adapted to a specific person. The pre-programmed positions can be stored in a memory and be activated by a user, for example via a smart phone using for example a Bluetooth connection enabled in the earbud wireless communication electronics.

In examples of embodiments wherein the indent or airing canal 11 is embodied, it is possible to fasten the earbud cushion 16 in three different and independent points on an ear canal wall and still have an acoustical controllable state.

When an earbud body 10 according to the present invention is to be removed from an ear canal, configured electronics inside the earbud body 10 will signal that a removal of the earbud body is possible when respective pressure signals are below a second predefined value, i.e., there is no longer a contact between the earbud cushion 16 and inside walls of an ear canal. This situation may be transmitted wirelessly to an outside unit, for example a smart phone.

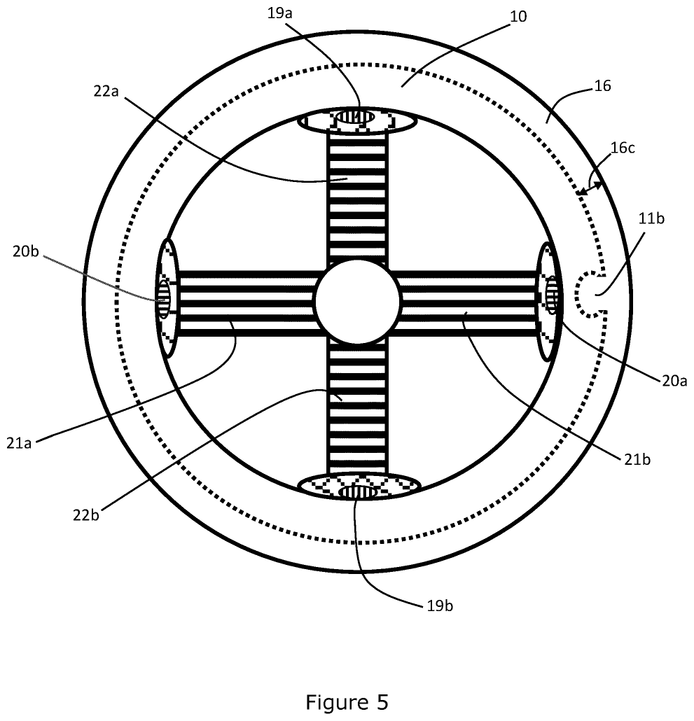

With reference to FIG. 5 all actuators 21a, 21b, 22a, 22b are activated, i.e., are extended. This results in a fastening of the earbud device inside an ear canal as well as blocking the orthogonal surface 11b the airing canal 11 (indent). This leaves a closed space between the loudspeaker 18 and an eardrum the loudspeaker is facing. The illustrated configuration provides an acoustical “closed” configuration, i.e., the space in between the loudspeaker 18 and an eardrum the loudspeaker is facing is a closed space. The distance 16c marked in FIG. 5 indicates the distance from the outer surface of the earbud body 10 and the outer surface of the ring-shaped part of the earbud cushion 16 in contact with ear canal walls, i.e., how far the earbud cushion surface is extended away from the earbud body surface.

The activation of the second actuator 21b adjacent to the orthogonal surface 11b of the airing canal 11 can be done gradually. Therefore, the amount of air that can pass from the ear canal opening towards the space in the ear canal in front of the eardrum can be controlled. Therefore, by activating the second actuator 21b extending the second actuator body length gradually the second actuator end 23b will push the cushion 16 towards the orthogonal surface 11b of the airing canal 11 thereby covering the surface gradually thereby throttling the air flow through the airing canal 11 until the second actuator end 23b has pushed the earbud cushion towards the ear canal wall thereby sealing the space inside the ear canal in front of the eardrum.

It is within the scope of the present invention that the ring-shaped part of the earbud cushion 16 does not need to touch for example the ear canal wall adjacent to the actuator end 23a of the first actuator located opposite to the second actuator 21b. Therefore, it can be left an opening which is a sort of an airing canal adjacent to the first actuator end 23a as well as an airing canal provided by the airing canal 11 (indent) on the side face of the earbud body 10 adjacent to the second actuator end 23b. However, this may depend on the anatomy of the ear canal if there will be left an opening adjacent to the first actuator end 23a. The airing canal or indent 11 guaranties that there will be an opening independent on the anatomy of a specific ear canal since the airing canal runs along the whole longitudinal length of the earbud body 10.

Therefore, extensions of respective actuator bodies can be done at the same time in for example two opposite directions. For example along the first diagonal direction constituted by the first and second actuator 21a, 21b but the extension should be stopped when the first pressure sensor 19a sends the feedback signal having an amplitude above a pre-defined amplitude level to the configured electronics controlling the extension of the first actuator 21a. The illustrated examples indicates that it is also beneficial to arrange one of the respective actuator bodies adjacent and in line with the orthogonal surface 11b of the airing canal 11. In this manner it is possible to vary the amount of unblocked surface area of the orthogonal surface 11b dependent on the amount of extension or respective reduction of the length of the adjacent actuator controlling the coverage of the orthogonal surface 11b of the airing canal 11.

In the example above, an actuator body can be further extended closing an unintentional opening located adjacent to for example the actuator end 23a of the first actuator 21a. If the second actuator 21b is activated to be extended further, the orthogonal surface 11b of the airing canal 11 is closed.

As can be understood, the closing and opening of airing canals can be gradual done by configured control signals extending or reducing the length of respective actuator bodies providing a means of controlling acoustical properties of the space formed between the loudspeaker 18 and the eardrum the loudspeaker is facing when inserted into an ear canal. This includes conditions formed by an open space to a closed space, and all intermediate airing canal profile dimensions controlled by the respective actuators.

Actuators used in embodiments of the present invention may have an extension length that is too short to achieve respective lengths required by a specific embodiment according to the present invention. This may be due to which technology is used when making an actuator. It is within the scope of the present invention to provide a serial coupling of two or more extendable actuator bodies that can be synchronized when extending such that the total possible extension length is a sum of the combined serial coupled actuator bodies. For example, the first actuator 21a may comprise a first sub-actuator 21a′ and a second sub-actuator 21a″ arranged in series. The respective control signals controlling extension and reduction of length of the respective sub-actuators are configured to operate the respective sub-actuators as if they were just one actuator body.

With reference to the accompanying figures an example of embodiment of the present invention may comprise:
an earbud cushion system attachable to a wireless earbud body comprising:
a support structure 17 extending through an earbud cushion body 16 from an end surface of the earbud body 10, wherein the support structure 17 supports at least:
a first actuator body 21a, a second actuator body 21b, a third actuator body 22a, a fourth actuator body 23b all attached in one end to an outer surface of the support structure 17 and in respective opposite ends of the respective actuator bodies to a respective actuator ending element 23a, 23b, 23c, 23d in contact with an inner surface of a ring-shaped part of the earbud cushion body 16, wherein
the first actuator body 21a and the second actuator body 21b span a first diagonal direction across a cross section of the ring-shaped part of the earbud cushion 16, and
the third actuator body 22a and the fourth actuator body 22b span a second diagonal direction across the cross section of the ring-shaped part of the earbud cushion 16.

It is further within the scope of the example of embodiment disclosed above that an angle between the first diagonal direction and the second diagonal direction is ninety degrees.

It is further within the scope of the example of embodiment disclosed above that an angle between a longitudinal direction of the first actuator body 21a and a longitudinal direction of the second actuator body 21b arranged on opposite sides of the outer surface of the support structure 17 is different from one hundred and eighty degrees.

It is further within the scope of the example of embodiment disclosed above that an angle between a longitudinal direction of the third actuator body 22a and a longitudinal direction of the fourth actuator body 22b arranged on opposite sides of the outer surface of the support structure 17 is different from one hundred and eighty degrees.

It is further within the scope of the example of embodiment disclosed above that a respective one of the respective actuator bodies 21a, 21b, 22a, 22b is formed by at least two sub-actuator bodies connected in series.

It is further within the scope of the example of embodiment disclosed above that electrical signal originating form configured electronics inside the earbud body 10 can extend or reduce a length of a respective one of the actuator bodies 21a, 21b, 22a, 22b.

It is further within the scope of the example of embodiment disclosed above that a length of an active electrical signal corresponds to an amount of extension or reduction in length of a connected actuator.

It is further within the scope of the example of embodiment disclosed above that respective actuator bodies 21a, 21b, 22a, 22b are attachable to the outer surface of the support structure 17 via an adapted bracket providing an adjustable position of the connected actuator body thereby adjusting a pressure point onto an inside surface of an ear canal when extending the connected actuator body.

It is further within the scope of the example of embodiment disclosed above that an angle between a longitudinal direction of an attached actuator body and a surface normal to the outer surface of the support structure 17 is adjustable thereby adjusting a pressure point onto an inside surface of an ear canal when extended the connected actuator body.

It is further within the scope of the example of embodiment disclosed above that respective actuator ending elements 23a, 23b, 23c, 23d comprises a respective pressure sensor 19a, 19b, 20a, 20b providing a feed-back signal to the configured electronics wherein the configured electronics stops an extension signal of an actuator if the pressure sensor inside the corresponding actuator ending element exceeds a configurable signal level.

It is further within the scope of the example of embodiment disclosed above that an Indent (11) on a side surface of the earbud body (10) may function as an acoustical vent, wherein a closing or opening of the acoustical vent is controlled by an amount of extension of an actuator body located adjacent to an opening of the indent (11).

### REFERENCE NUMERALS

10 Earbud body
11 Airing canal (indent)
11a Orthogonal end surface
11b Orthogonal end surface
12 Wireless antenna
13 Inclination angle α′
14 Front body part inclination line
15 Inclination angle α
16 Earbud cushion
16a Earbud cushion extension
16b Distance to outer earbud cushion surface
16c Distance to outer earbud cushion surface
17 Support structure
17a Connection element
17b Connection element
18 Loudspeaker
19a First pressure sensor
19b Second pressure sensor
20a Third pressure sensor
20b Fourth pressure sensor
21a First actuator
21b Second actuator
22a Third actuator
22b Fourth actuator
23a First actuator ending element
23b Second actuator ending element
23c Third actuator ending element
23d Fourth actuator ending element

1. An earbud cushion system attachable to a wireless earbud body comprising:
a support structure extending through an earbud cushion body from an end surface of the earbud body, wherein the support structure supports at least:
a first actuator body, a second actuator body, a third actuator body, a fourth actuator body all attached in one end to an outer surface of the support structure and in respective opposite ends of the respective actuator bodies to a respective actuator ending element in contact with an inner surface of a ring-shaped part of the earbud cushion body, wherein
the first actuator body and the second actuator body span a first diagonal direction across a cross section of the ring-shaped part of the earbud cushion, and the third actuator body and the fourth actuator body span a second diagonal direction across the cross section of the ring-shaped part of the earbud cushion.

2. The system of claim 1, wherein an angle between the first diagonal direction and the second diagonal direction is ninety degrees.

3. The system of claim 1, wherein an angle between a longitudinal direction of the first actuator body and a longitudinal direction of the second actuator body arranged on opposite sides of the outer surface of the support structure is different from one hundred and eighty degrees.

4. The system of claim 1, wherein an angle between a longitudinal direction of the third actuator body and a longitudinal direction of the fourth actuator body arranged on opposite sides of the outer surface of the support structure is different from one hundred and eighty degrees.

5. The system of claim 1, wherein a respective one of the respective actuator bodies is formed by at least two sub-actuator bodies connected in series.

6. The system of claim 1, wherein electrical signals originating form configured electronics inside the earbud body can extend or reduce a length of a respective one of the actuator bodies.

7. The system of claim 6, wherein a length of an active electrical signal corresponds to an amount of extension or reduction in length of a connected actuator.

8. The system of claim 1, wherein respective actuator bodies are attachable to the outer surface of the support structure via an adapted bracket providing an adjustable position of the connected actuator body thereby adjusting a pressure point onto an inside surface of an ear canal when extending the connected actuator body.

9. The system of claim 8, wherein an angle between a longitudinal direction of an attached actuator body and a surface normal to the outer surface of the support structure is adjustable thereby adjusting a pressure point onto an inside surface of an ear canal when extended the connected actuator body.

10. The system of claim 6, wherein respective actuator ending elements comprises a respective pressure sensor providing a feed-back signal to the configured electronics wherein the configured electronics stops an extension signal of an actuator if the pressure sensor inside the corresponding actuator ending element exceeds a configurable signal level.

11. The system of claim 1, wherein an indent on a side surface of the earbud body functions as an acoustical vent wherein a closing or opening of the acoustical vent is controlled by an amount of extension of an actuator body located adjacent to an opening of the indent.
